(19) United States
(12) Patent Application Publication
(10) Pub. No.: US 2025/0059999 A1
(43) Pub. Date: Feb. 20, 2025

(54) JOINING ELEMENT AND JOINING METHOD THEREOF

(71) Applicant: NES LIMITED, Taipei City (TW)

(72) Inventors: Ding-jun LIN, Taipei City (TW); Rong-shean LEE, Taipei City (TW)

(21) Appl. No.: 18/795,393

(22) Filed: Aug. 6, 2024

(30) Foreign Application Priority Data
Aug. 15, 2023 (TW) 112130702

(51) Int. Cl. F16B 25/00

(52) U.S. Cl. CPC F16B 25/0084

(57) ABSTRACT

A joining element and joining method thereof are provided. The joining element comprises a head section, a rib section, and a tip section, wherein each cross section of the tip section has a geometric shape, and the geometric shape is formed by overlapping a plurality of ellipses. When the joining element applies downward pressure and rotational force on an assembly component, an inner concave portion of the geometric shape generates more plastic deformation heat than fraction heat on the material of the joining element. It facilitates the softening of the material in the assembly component, allowing for greater plastic deformation and, in turn, improves the assembly efficiency.

### CROSS REFERENCE TO RELATED APPLICATIONS

This application claims priority to Taiwan Application Serial Number 112130702, filed on Aug. 15, 2023, which is incorporated herein by reference.

### FIELD OF THE INVENTION

Present disclosure relates to a joining element and a joining method thereof, and more particularly to a joining element that can improve the formability of materials through the heat of friction and plastic deformation, and a joining method that uses the joining element to connect multiple materials or multiple heterogeneous materials without pre-drilled holes.

### BACKGROUND OF THE INVENTION

In traditional industry, the assembly of multiple units (such as two plates) can be done through welding or mechanical connection, wherein the mechanical connection has the characteristics of high strength and repeatable assembly and is easy to disassemble and assemble during maintenance. Moreover, two plates are to be detachably connected to each other, usually by screwing with joining elements such as screws or threads. Screwing the joining elements usually requires pre-drilling the elements and the clamping elements, where the pre-drilled holes can be achieved by drilling, punching, deep drawing or similar means. The installation method of the joining components requires drilling holes at designated positions through other processing methods, and placing corresponding matching components, such as bolts and nuts, before the installation of the two plates can be carried out. In other words, screwing the joining element requires pre-drilled holes, which results in poor assembly efficiency.

In order to overcome the shortcomings, relevant manufacturers have proposed screws that combine forming holes and tapped threads, such as U.S. Pat. Nos. 8,348,572B2, 8,939,692B2 and 10,508,676B2. The screw that combines forming holes and tapping with a tapered head and threads on the rod body. According to this design, as the screw is driven into the plate, the tapered head pierces the hole into the plate until the threads of the screw finally formed threads in the plate.

However, screws that combine pierced holes and tapped threads produce low plastic deformation in the plate and cannot effectively fix the screws on the plate. The pierced holes created when the screws are driven into the plate have low heat generation efficiency and cannot effectively promote the material flow of the plate. The fastening of screws into the plate is insufficient, thereby reducing the manufacturing efficiency of the production line.

As a result, it is necessary to provide a joining element and a joining method thereof to solve the problems existing in the conventional technologies, as described above.

### SUMMARY OF THE INVENTION

An object of present disclosure is to provide a joining element and a joining method thereof. Through the design of each cross section of the tip section of the joining element in a geometric shape of multiple ellipses, when the joining element presses and rotates the assembly component, the inner concave portion disposed between two adjacent ellipses generates more plastic deformation heat for the material of the joining element. It facilitates the softening of the material in the assembly component, allowing for greater plastic deformation and, in turn, improves the assembly efficiency.

To achieve the above object, the present disclosure provides a joining element configured to be driven by a rotary tool to rotate along an axis, wherein the joining element comprises a head section, a rib section, and a tip section; the head section is configured to be engaged with the rotary tool; the rib section comprises a body and a plurality of ribs, wherein the body extends from the head section along the axis, and the ribs are disposed on a surface of the body; the tip section comprises a connecting end and a contact end, wherein the connecting end is connected to one end of the body of the rib section; the contact end is opposite to the connecting end and the contact end is configured to contact an assembly component; each cross section of the tip section has a geometric shape; the geometric shape is formed by overlapping a plurality of ellipses, and an inner concave portion is located at a connection between two adjacent ellipses.

In one embodiment of present disclosure, the shapes of the ellipses are the same, and an angle between the major axes of two adjacent ellipses is between 45 degrees and 90 degrees.

In one embodiment of present disclosure, a ratio of a major axis to a minor axis of the ellipses is R, and 1>R>0.

In one embodiment of present disclosure, an area of a cross section of the tip section located at the connecting end tapers toward an area of a cross section of the tip section located at the contact end, and a major diameter of a cross section of the tip section located at the connecting end is less than or equal to a diameter of the body of the rib section.

In one embodiment of present disclosure, the ratio of a major axis to a minor axis of the ellipses in a cross section of the tip section near the connecting end is close to 1.

In one embodiment of present disclosure, each center line on the cross section is perpendicular to the axis.

In one embodiment of present disclosure, the ribs comprise a plurality of spiral teeth or a plurality of annular protrusions arranged in a row.

In one embodiment of present disclosure, the head section comprises a fitting portion, a flange, and a recessed portion; the fitting portion is disposed on a top surface of the flange and the fitting portion is configured to be engaged with the rotary tool; the body of the rib section extends from a bottom surface of the flange, and the recessed portion is disposed on the bottom surface of the flange and surrounds the body.

To achieve the above object, the present disclosure provides a joining method of a joining element, wherein the joining method comprising steps of: a first phase, engaging a rotary tool to a head section of a joining element, contacting a contact end of a tip section of the joining element to a surface of an assembly component, and rotating the rotary tool to generate a frictional heat greater than a plastic deformation heat between the tip section of the joining element and the assembly component, wherein each cross section of the tip section has a geometric shape; the geometric shape is formed by overlapping a plurality of ellipses, and an inner concave portion is located at a connection between two adjacent ellipses; a second phase, applying an axial pressure and a rotational speed through the rotary tool to drive the joining element to press down and rotate the assembly component to generate a plastic deformation heat greater than a frictional heat between the tip section of the joining element and the assembly component, wherein the tip section of the joining element penetrates into an interior of the assembly component to form a hole and a bulge around the hole; a third phase, piercing a rib section of the joining element into the hole, and pressing the head section of the joining element against the bulge of the assembly component.

In one embodiment of present disclosure, a thermal expansion coefficient of the assembly component is greater than a thermal expansion coefficient of the joining element.

As described above, the geometric shape of the cross section of the tip section has a plurality of ellipses. When the joining element presses and rotates the assembly component, the inner concave portion formed between two adjacent ellipses makes more plastic deformation heat for the material of the joining element. It facilitates the softening of the material in the assembly component, allowing for greater plastic deformation and, in turn, improves the assembly efficiency. In other words, frictional heat and plastic deformation heat are used to increase heat generation, so that the temperature generated by the joining element of the present disclosure on the assembly component is higher than that of the conventional screw in the prior art. The material of the assembly component can reach an appropriate temperature more quickly and soften to form good plastic flow. Therefore, the assembly component is easily punctured to form the hole. After the material is cooled, it forms a good tightening interference with the rib section, which can form resistance to the push out/pull out and torsion of the joining element in the assembly component.

### DESCRIPTION OF THE DRAWINGS

FIG. 1 is a side view of a joining element according to an embodiment of the present disclosure.

FIG. 2 is a perspective view of the joining element according to an embodiment of the present disclosure.

FIG. 3A is a schematic diagram of a geometric shape of cross section A-A in FIG. 1.

FIG. 3B is a schematic diagram of another geometric shape of cross section A-A in FIG. 1.

FIG. 3C is a schematic diagram of another geometric shape of cross section A-A in FIG. 1.

FIG. 4A is a schematic diagram of a joining method for joining the joining element in contact with an assembly component according to an embodiment of the present disclosure.

FIG. 4B is a schematic diagram of a joining method for piercing an assembly part with a joining element according to an embodiment of the present disclosure.

FIG. 4C is a schematic diagram of a joining method for fastening the joining element to the assembly component according to an embodiment of the present disclosure.

FIG. 5A is a schematic diagram of the plastic deformation produced by the joining element and a conventional screw on the assembly component according to an embodiment of the present disclosure.

FIG. 5B is a schematic diagram of the temperature generated on the assembly component by the joining element and the conventional screw according to an embodiment of the present invention.

FIG. 6 is a flow chart of a joining method of the joining element according to an embodiment of the present invention.

### DETAILED DESCRIPTION OF THE PREFERRED EMBODIMENTS

The structure and the technical means adopted by present disclosure to achieve the above and other objects can be best understood by referring to the following detailed description of the preferred embodiments and the accompanying drawings. Furthermore, directional terms described by present disclosure, such as upper, lower, front, back, left, right, inner, outer, side, longitudinal/vertical, transverse/horizontal, etc., are only directions by referring to the accompanying drawings, and thus the used directional terms are used to describe and understand present disclosure, but present disclosure is not limited thereto.

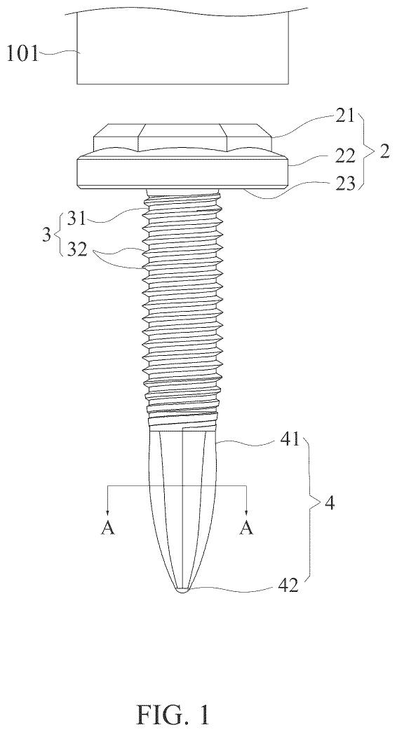

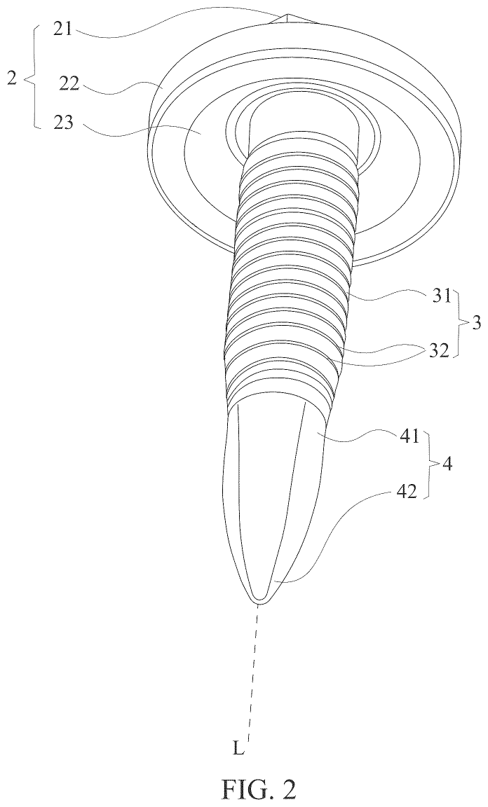

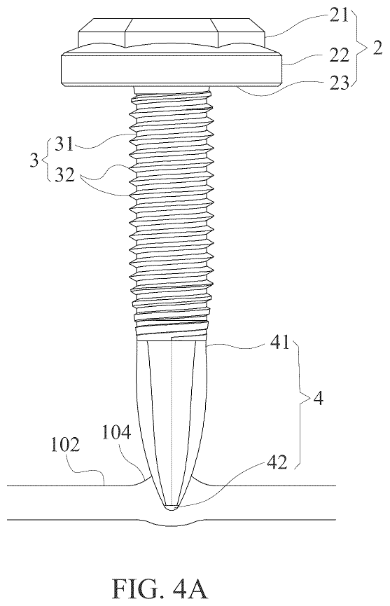

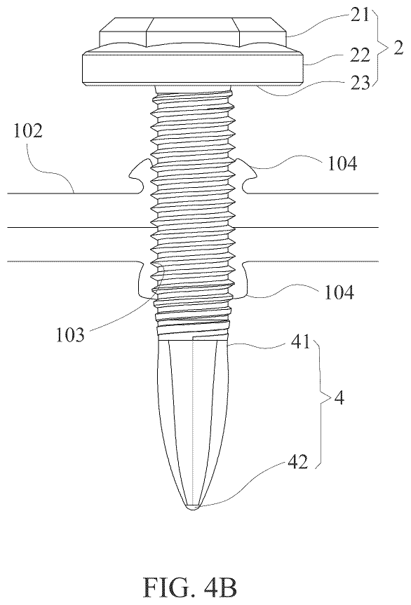

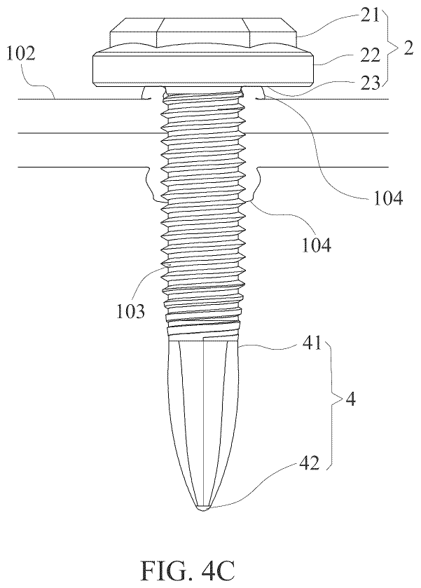

Please refer to FIG. 1 and FIG. 2, a joining element according to a preferred embodiment of present disclosure is illustrated. The joining element is configured for being driven by a rotary tool 101 to rotate along an axis L for mounting on an assembly component 102 without pre-drilled holes (as shown in FIG. 4A). The joining element comprises a head section 2, a rib section 3, and a tip section 4. The detailed structure of each component, assembly relationships, and principles of operation in present disclosure will be described in detail hereinafter.

Please refer to FIG. 1 and FIG. 2, the head section 2 is configured to be engaged with the rotary tool 101 (such as a hex socket). Specifically, the head section 2 comprises a fitting portion 21, a flange 22, and a recessed portion 23, wherein the fitting portion 21 is disposed on a top surface of the flange 22 and the fitting portion 21 is configured to be engaged with the rotary tool 101. The recessed portion 23 is disposed on a bottom surface of the flange 22.

Please refer to FIG. 1 and FIG. 2, the rib section 3 comprises a body 31 and a plurality of ribs 32, wherein the body 31 extends from the head section 2 along the axis L and the ribs 32 are disposed on a surface of the body 31. Specifically, the body 31 of the rib section 3 extends from the bottom surface of the flange 22 of the head section 2 and the recessed portion 23 surrounds an outer surface of the body 31. In the embodiment, the ribs 32 have a plurality of spiral teeth (as shown in FIG. 1) or a plurality of annular protrusions arranged in a row.

Please refer to FIG. 1, FIG. 2, and FIG. 4B, the ribs 32 can specifically form axial interference and resistance to torsion on a hole 103 of the assembly component 102. The recesses located between the ribs 32 can cause the material of the assembly component 102 to flow into them to achieve a tight fit effect. In the embodiment, a thermal expansion coefficient of the assembly component 102 is greater than a thermal expansion coefficient of the joining element. For example, the assembly component 102 is made of two stacked aluminum alloy plates (the thermal expansion coefficient is 20), and the joining element is low alloy steel (the thermal expansion coefficient is 12). During the installation process, there is a heat transfer temperature difference between the joining element and the assembly component 102, wherein 11% of the heat is conducted to the joining element and 89% of the heat is conducted to the component 102. Since the thermal expansion coefficients of the joining element and the assembly component 102 are different, wherein the assembly component 102 has a large amount of shrinkage, so after the puncture is completed, a tight fit will occur when the material cools (as shown in FIG. 4C).

Please refer to FIG. 1 and FIG. 2, the tip section 4 comprises a connecting end 41 and a contact end 42. The connecting end 41 is connected to one end of the body 31 of the rib section 3 and the body 31 is located between the head section 2 and the tip section 4. The contact end 42 is opposite to the connecting end 41 and the contact end 42 is configured to contact the assembly component 102 (as shown in FIG. 4A).

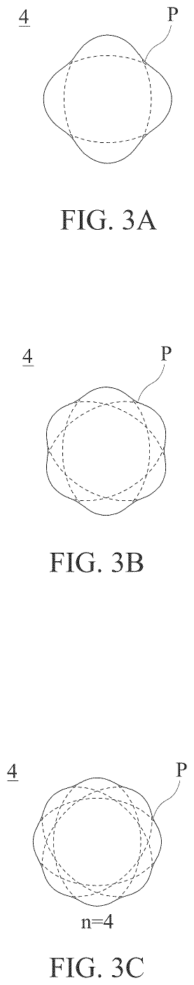

Please refer to FIG. 2 and FIG. 3A, each cross section of the tip section 4 has a geometric shape and each center line on the cross section is perpendicular to the axis L. Specifically, the geometric shape is formed by overlapping a plurality of ellipses, the shapes of the ellipses are the same and their centers coincide with each other. The major axes of the ellipses are arranged in a ring shape.

Specifically, the geometric shape of the cross section of the tip section 4 is composed of multiple ellipses, the assembly component 102 can be heated and plastically deformed, and the structure can adjust the proportion of the geometric parameters of the ellipse to heat up and plastically deform the assembly component 102. For example, the ratio of a major axis to a minor axis of the ellipses is R, and 1>R>0. During the puncture process, the tip section 4 can be manipulated on the assembly component 102 to generate heat due to pressing, friction, and rotation, as well as heat generated by plastic deformation due to rotation.

Please refer to FIG. 2 and FIG. 3A, in the geometric shape, the connection between two adjacent ellipses forms a smooth inner concave portion P, and an angle between the major axes of two adjacent ellipses is between 45 degrees and 90 degrees. For example, the number of these ellipses is 2, and the angle between the major axes of two adjacent ellipses is 90 degrees (as shown in FIG. 3A), the number of these ellipses is 3, and the angle between the major axes of two adjacent ellipses is 60 degrees (as shown in FIG. 3B), and the number of these ellipses is 4, and the angle between the major axes of two adjacent ellipses is 45 degrees (as shown in FIG. 3C).

Further, since the connection between two adjacent ellipses forms an inward concave feature, the concave feature can change in depth with the number of these ellipses. The deeper concave features will form sharpening, and the depth of the concave features will become shallower as the number of ellipses increases. Therefore, by forming the inner concave portion P into a smooth shape, the concave feature can be smoothed, thereby reducing the wear and tear of the forming die during the manufacturing process.

Please refer to FIG. 2 and FIG. 3A, in the embodiment, an area of a cross section of the tip section 4 located at the connecting end 41 tapers toward an area of a cross section of the tip section 4 located at the contact end 42, and a major diameter of a cross section of the tip section 4 located at the connecting end 41 is less than or equal to a diameter of the body 31 of the rib section 3. Moreover, In a cross section of the tip section 4 close to the connecting end 41, the ratio of a major axis to a minor axis of the ellipses in a cross section of the tip section 4 near the connecting end 41 is close to 1, and the end of the contact end 42 can also be designed in the shape of a round head (as shown in FIG. 1).

According to the above structure, the rotary tool 101 is engaged with the fitting portion 21 of the head section 2, and then the head section 2 is driven to rotate along the axis L and axial force is applied to the flange 22 to provide rotation, torsion and axial downward force of the joining element. During the installation process, the material of the assembly component 102 is softened through frictional heat generation, and then the assembly component 102 is punctured through plastic deformation by the tip section 4. The rotation and downward pressure of the tip section 4 heats the material to form the hole 103 and a bulge 104 until the head section 2 of the joining element presses down to the bulge 104 to make the assembly component 102 and the head section 2 contact each other, wherein the bulge 104 is limited in the recessed portion 23, thereby achieving the effect of limiting and tightening.

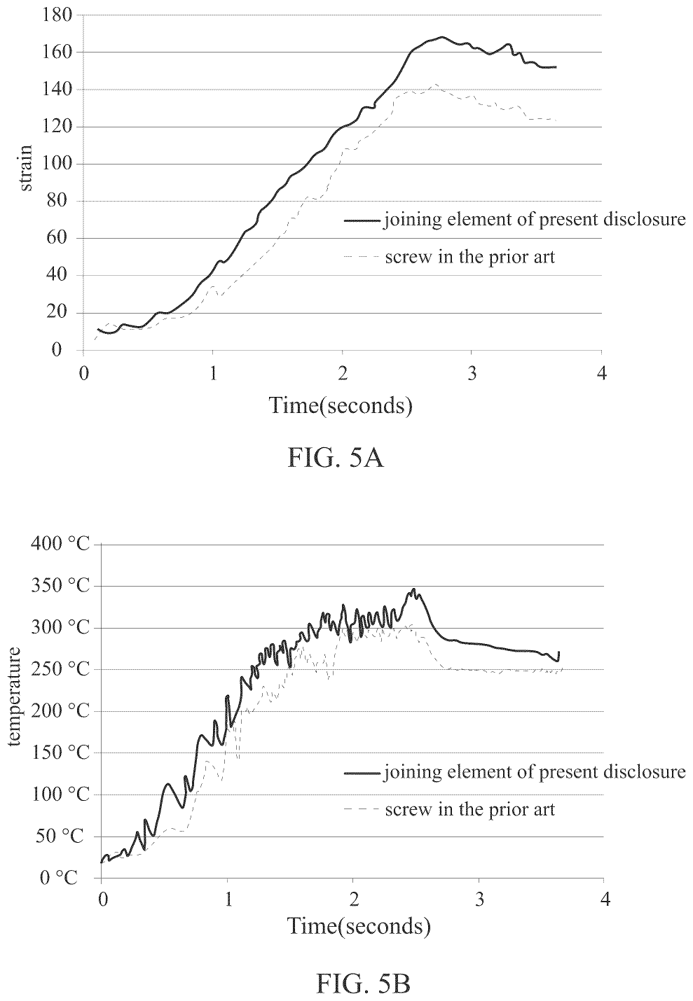

Further, after the assembly component 102 is installed on the rib section 3, the material of the assembly component 102 will cool and shrink to produce interference fitting. The geometric shape of the cross section of the tip section 4 can resist the effects of push out/pull out and torsion from the assembly component 102, so that the plastic deformation produced by the joining element of the present disclosure on the assembly component 102 is higher than that of the conventional screw in the prior art (as shown in FIG. 5A).

As described above, the geometric shape of the cross section of the tip section 4 has a plurality of ellipses. When the joining element presses and rotates the assembly component 102, the inner concave portion P formed between two adjacent ellipses makes more plastic deformation heat for the material of the joining element. It is easier to soften the material of the assembly component 102 and obtain a larger amount of plastic deformation, thereby improving assembly efficiency. In other words, frictional heat and plastic deformation heat are used increasing heat generation, so that the temperature generated by the joining element of the present disclosure on the assembly component 102 is higher than that of the conventional screw in the prior art (as shown in FIG. 5B). The material of the assembly component 102 can reach an appropriate temperature more quickly and soften to form good plastic flow. Therefore, the assembly component 102 is easily punctured to form the hole 103. After the material is cooled, it forms a good tightening interference with the rib section 3, which can form resistance to the push out/pull out and torsion of the joining element in the assembly component 102.

Further, The joining element of the present disclosure only needs to penetrate the assembly component 102 in the axial direction without placing any auxiliary tools at the opposite location. After being punctured, the material of the assembly component 102 has good joinability after cooling, and the assembly component 102 can be used as a counterpart for assembly (such as a nut). It can eliminate the need for pre-drilled holes before assembly, and can reduce manufacturing processes such as drilling operations, thereby improving overall production efficiency and effectively reducing material costs.

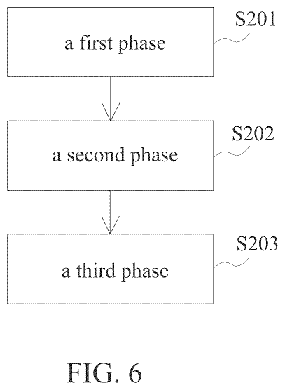

Please refer to FIG. 6 and FIG. 1, a joining method of a joining element according to a preferred embodiment of present disclosure is illustrated. The method is operated by the mentioned joining element, wherein the joining element is driven to rotate by a rotary tool 101. The joining method includes a first phase S201, a second phase S202 and a third phase S203. The relationship and operation principle of each step in present disclosure will be described in detail hereinafter.

Please refer to FIG. 6, FIG. 1, and FIG. 2, in the first phase S201, the rotary tool 101 is assembled into a head section 2 of a joining element, and then a contact end 42 of a tip section 4 of the joining element is contacted with a surface of an assembly component 102 (as shown in FIG. 4A) and rotated. The frictional heat generated between the tip section 4 of the joining element and the assembly component 102 is greater than the plastic deformation heat, so that the material of the assembly component 102 gradually heats up and produces plastic deformation. For example, the operation is between 0 seconds and 0.3 seconds (as shown in FIG. 5A and FIG. 5B).

Specifically, each cross section of the tip section 4 has a geometric shape, and the geometric shape is formed by overlapping a plurality of ellipses (as shown in FIG. 3A). A connection between two adjacent ellipses forms an inner concave portion P. In the embodiment, the tip section 4 contacts a position of the assembly component 102 without pre-drilled holes (or with pre-drilled holes).

Please refer to FIG. 6, FIG. 1, and FIG. 2, in the second phase S202, the rotary tool 101 is rotated along an axis L to apply an axial pressure and a rotational speed to drive the joining element to press down and rotate the assembly component 102. The plastic deformation heat generated between the tip section 4 of the joining element and the assembly component 102 is greater than the friction heat, thus significantly increasing the temperature and plastic deformation of the material of the assembly component 102. For example, the operation is between 0.3 seconds and 2.8 seconds (as shown in FIG. 5A and FIG. 5B).

Specifically, the tip section 4 of the joining element penetrates into the interior of the assembly component 102 to form a hole 103, and a bulge 104 is formed around the hole 103, wherein the bulge 104 is raised toward two opposite sides of the hole 103. In the embodiment, the rotary tool 101 applies a rotation speed of 4500 rev/min (revolutions per minute, rpm) to the head section 2 and the head section 2 is punctured and assembled at a speed of 300 mm/min (distance per minute).

Please refer to FIG. 6, FIG. 2, and FIG. 4C, in the third phase S203, a rib section 3 of the joining element is pierced into the hole 103, and the head section 2 of the joining element is pressed against the bulge 104 of the assembly component 102. At this time, the material of the assembly component 102 gradually cools down and the plastic deformation begins to decrease. For example, the operation is between 2.8 seconds and 4 seconds (as shown in FIG. 5A and FIG. 5B).

Please refer to FIG. 4A and FIG. 4B, according to the above content, the joining element of the present disclosure uses preloaded axial pressure and rotational speed to cause local heating by friction at the contact boundary at the position of the assembly component 102 without pre-drilled holes under the lower rotational speed and downward force of the overall manufacturing process, wherein the downward force causes the assembly component 102 to be punctured to form the hole 103. After the hole 103 is partially formed in the assembly component 102, the size of the hole 103 increases as the tip section 4 is pressed down. The assembly component 102 generate heat due to friction and plastic deformation, and the material of the assembly component 102 will soften during the continuous heating process. The material of the assembly component 102 flows towards the recesses of the ribs 32 until the head section 2 of the joining element is pressed down to the bulge 104, so that the assembly component 102 and the head section 2 come into contact with each other. As shown in FIG. 4C, the bulge 104 of the assembly component 102 is squeezed by the head section 2 of the joining element, and the downward pressure of the joining element reaches the limit. The rotational torque value of the joining element increases due to locking, the rotary tool 101 stops rotating and pressing down. The joining element and the assembly component 102 begin to cool and form interference contraction to complete the installation operation.

As described above, the geometric shape of the cross section of the tip section 4 has a plurality of ellipses. When the joining element presses and rotates the assembly component 102, the inner concave portion P formed between two adjacent ellipses exhibits more plastic deformation heat for the material of the joining element. It is easier to soften the material of the assembly component 102 and obtain a larger amount of plastic deformation (as shown in FIG. 5A), thereby improving assembly efficiency. In other words, frictional heat and plastic deformation heat are used for increasing heat generation, so that the temperature generated by the joining element of the present disclosure on the assembly component 102 is higher than that of the conventional screw in the prior art (as shown in FIG. 5B). The material of the assembly component 102 can reach an appropriate temperature more quickly and soften to form good flow. Therefore, the assembly component 102 is easily punctured to form the hole 103. After the material is cooled, it forms a good plastic tightening interference with the rib section 3, which can form resistance to the push out/pull out and torsion of the joining element in the assembly component 102.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A joining element configured to be driven by a rotary tool to rotate along an axis, comprising:
a head section configured to be engaged with the rotary tool;
a rib section comprising a body and a plurality of ribs, wherein the body extends from the head section along the axis, and the ribs are disposed on a surface of the body; and
a tip section comprising a connecting end and a contact end, wherein the connecting end is connected to one end of the body of the rib section; the contact end is opposite to the connecting end and the contact end is configured to contact an assembly component; each cross section of the tip section has a geometric shape; the geometric shape is formed by overlapping a plurality of ellipses, and an inner concave portion is located at a connection between two adjacent ellipses.

2. The joining element according to claim 1, wherein the shapes of the ellipses are the same, and an angle between the major axes of two adjacent ellipses is between 45 degrees and 90 degrees.

3. The joining element according to claim 1, wherein a ratio of a major axis to a minor axis of the ellipses is R, and 1>R>0.

4. The joining element according to claim 3, wherein an area of a cross section of the tip section located at the connecting end tapers toward an area of a cross section of the tip section located at the contact end, and a major diameter of a cross section of the tip section located at the connecting end is less than or equal to a diameter of the body of the rib section.

5. The joining element according to claim 3, wherein the ratio of a major axis to a minor axis of the ellipses in a cross section of the tip section near the connecting end is close to 1.

6. The joining element according to claim 1, wherein each center line on the cross section is perpendicular to the axis.

7. The joining element according to claim 1, wherein the ribs comprise a plurality of spiral teeth or a plurality of annular protrusions arranged in a row.

8. The joining element according to claim 1, wherein the head section comprises a fitting portion, a flange, and a recessed portion; the fitting portion is disposed on a top surface of the flange and the fitting portion is configured to be engaged with the rotary tool; the body of the rib section extends from a bottom surface of the flange, and the recessed portion is disposed on the bottom surface of the flange and surrounds the body.

9. A joining method of a joining element, comprising steps of:
a first phase, engaging a rotary tool to a head section of a joining element, contacting a contact end of a tip section of the joining element to a surface of an assembly component, and rotating the rotary tool to generate a frictional heat greater than a plastic deformation heat between the tip section of the joining element and the assembly component, wherein each cross section of the tip section has a geometric shape; the geometric shape is formed by overlapping a plurality of ellipses, and an inner concave portion is located at a connection between two adjacent ellipses;
a second phase, applying an axial pressure and a rotational speed through the rotary tool to drive the joining element to press down and rotate the assembly component to generate a plastic deformation heat greater than a frictional heat between the tip section of the joining element and the assembly component, wherein the tip section of the joining element penetrates into an interior of the assembly component to form a hole and a bulge around the hole;
a third phase, piercing a rib section of the joining element into the hole, and pressing the head section of the joining element against the bulge of the assembly component.

10. The joining method according to claim 9, wherein a thermal expansion coefficient of the assembly component is greater than a thermal expansion coefficient of the joining element.
